(19) United States
(12) Patent Application Publication
(10) Pub. No.: US 2007/0124745 A1
(43) Pub. Date: May 31, 2007

(54) Cool air cooling device for optical disks

(76) Inventors: Ryoko Kitano, Tokushima (JP); Noriyuki Ikeuchi, Tokushima (JP); Toshinori Shinohara, Tokushima (JP)

Correspondence Address: FLYNN THIEL BOUTELL & TANIS, P.C., 2026 RAMBLING ROAD, KALAMAZOO, MI, 49008-1631, US

(21) Appl. No.: 10/581,704

(22) PCT Filed: Dec. 9, 2004
(86) PCT No.: PCT/JP04/18351

§ 371 Date: Jun. 5, 2006

(30) Foreign Application Priority Data
Dec. 9, 2003 (JP) 2003-409871

(51) Int. Cl. G11B 33/14

(52) U.S. Cl. 720/649

(57) ABSTRACT

To provide a cool air cooling device for optical disks where cooling of disk substrates immediately after injection molding thereof can be performed efficiently and a number of disk substrates can be accommodated in a limited space. A cool air cooling device (4) for optical disks having transfer means for transferring disk substrates in their standing state, wherein the transfer means is provided with a plurality of feed screw shafts driven for synchronous rotation to support and place disk substrates at a plurality of points, and the pitch of the threads formed in the feed screw shaft differs according to the axial positions of the threads.

### FIELD OF THE INVENTION

The present invention relates to a cool air cooling device for optical disks, and in particular to a cool air cooling device for optical disks provided with transfer means for transferring disk substrates formed using synthetic resin or the like in their standing state to efficiently cool the disk substrates.

### BACKGROUND ART

In a manufacturing apparatus for optical disks, conventionally, disk substrates are formed from such material as synthetic resin using, for example, an injection molding.

Then, the disk substrates immediately after the injection molding are put in a high temperature state (for example, about 80° C.), where warping has occurred in the disk substrates themselves.

Such disk substrates are cooled to a predetermined temperature (for example, 23° C. or so) by a cooling device having an air conditioning chamber before they are transferred to the next step.

In the cooling device, the disk substrates are transferred in the air conditioning chamber (cooled by cool air) held at a fixed temperature while placed on transfer means.

Then, the disk substrates are cooled to a predetermined temperature within the air conditioning chamber for a predetermined time period so that their warps are cancelled.

As the transfer means for transferring disk substrates which is provided in the cool air cooling device, one where a plurality of ball screws formed with threads at a fixed pitch are used is known (see Patent Literature 1).

That is, the transfer device has a structure that disk substrates are inserted into screw grooves of the ball screws and the disk substrates are transferred in a standing state according to rotation of the ball screws.

In this case, intervals between adjacent disk substrates are expanded to a fixed width to such an extent that cool air can pass smoothly so as to be capable of efficiently cooling the disk substrates.

Patent Literature 1: JP-A-2002-92967 (Paragraph 0023 and FIG. 4)

### DESCRIPTION OF THE INVENTION

Problem to be Solved by the Invention

However, in a cool air cooling device for optical disks such as described above, since intervals between disk substrates are uniformly expanded at a fixed pitch, it is necessary to extend a length of ball screws for supporting disk substrates in order to receive and cool many disk substrates in the air conditioning chamber.

However, regarding a space, there is such a problem that, when the length of the ball screws is extended, the air conditioning chamber is also made large correspondingly, which results in requirement for a boarder floor area.

The present invention has been made in view of these circumstances, and an object thereof is to provide a cool air cooling device for optical disks where cooling of disk substrates immediately after injection molding thereof is performed efficiently and many disk substrates can be accommodated in a limited cooling space.

Means for Solving the Problem

As the result of keen research to such a problem, the present inventors have found that the above-described problems have been solved by making the pitch on a feed screw shaft to differ according to the axial positions thereof, and they have completed the present invention based upon this finding.

That is, the present invention lies in (1) a cool air cooling device for optical disks having transfer means for transferring disk substrates in a standing state, wherein the transfer means is provided with a plurality of feed screw shafts driven for synchronous rotation to support and place disk substrates at a plurality of points, and the pitch of threads formed on the feed screw shaft differs according to the axial positions of the threads.

Further, the present invention lies in (2) a cool air cooling device for optical disks described in the above (1), wherein the feed screw shaft has a first region portion positioned at a carrying-in side of disk substrates and a second region portion positioned at a side of carrying-out of disk substrates, and the pitch of the threads formed on the first region portion is larger than the pitch of the threads formed on the second region portion.

Furthermore, the present invention lies in (3) a cool air cooling device for optical disks described in the above (2), wherein an intermediate region portion whose pitch gradually decreases from the first region portion to the second region portion is provided between the first region portion and the second region portion.

Moreover, the present invention lies in (4) a cool air cooling device for optical disks described in the above (2), wherein the first region portion is longer than the second region portion.

Further, the present invention lies in (5) a cool air cooling device for optical disks described in the above (1), further comprising cool air blowing means for blowing cool air toward the disk substrates in a standing state from the above.

Furthermore, the present invention lies in (6) a cool air cooling device for optical disks described in the above (1), further comprising an air conditioning chamber for covering the disk substrates in the standing state, and cool air supplying means for supplying cool air in the air conditioning chamber.

Moreover, the present invention lies in (7) a cool air cooling device for optical disks described in the above (1), wherein the disk substrates are supported at three points, and one point of the three points is shared for supporting adjacent disk substrates.

The present invention can adopted a combination of two or more selected from the above (1) to (7), if the combination satisfies the object of the present invention.

Advantage of the Invention

According to the present invention, the disk substrates supplied to the cool air cooling device is transferred while they are supported by the transfer means provided with the plurality of feed screw shafts driven for synchronous rotation in a standing state, and they are cooled during transfer thereof, but since the pitch of threads formed on the feed screw shafts differs according to the axial positions of the threads, more disk substrates can be accommodated using the feed screw shafts having a fixed length by making large the pitch of the threads on the carrying-in side where warp of the disk substrates is large and making small the pitch of the threads on the carrying-out side where warp of the disk substrates is small.

Further, the feed screw shaft has the first region portion on the side where the disk substrates are carried in and a second region portion on the side where the disk substrates are carried out, and the pitch of the threads formed on the first region portion is made larger than the pitch of the threads formed on the second region portion.

Intermediate region portion whose pitch decreases gradually from the first region portion to the second region portion is formed between the first region portion and the second region portion.

Therefore, since the pitch is large in the first region portion, the disk substrates supported in the standing state are reduced in mutual thermal influence, they are prevented from contacting with one another mutually, and passage of cool air is facilitated so that cooling is promoted.

On the other hand, since the pitch is small in the second region portion, staying time is extended according to lowering of a feed velocity for the disk substrates, so that cooling of disk substrates whose warps are reduced or cancelled can be promoted.

In addition, since disk substrates can be supported to a high density in the region, an accommodation amount of the disk substrates can be made large.

Further, since the intermediate region portion whose pitch decreases gradually from the first region portion to the second region portion is provided, load acting on portions of the disk substrates contacting with the feed screw shaft can be reduced without rapidly decreasing the velocity of the substrate disks during conveying thereof.

Then, since a fixed pitch is not adopted wholly so as to conform with the pitch of the threads in the first region portion, it becomes unnecessary to increase the length of the air conditioning chamber without reason, so that many disk substrates can be accommodated in a limited cooling space.

### BEST MODE FOR CARRYING-OUT OF THE INVENTION

Preferred embodiments of a cool air cooling device for optical disks of the present invention will be explained below with reference to the drawings.

FIG. 1 shows an outline of an optical disk manufacturing apparatus including a cool air cooling device for optical disks.

The optical disk manufacturing apparatus 1 is provided with an injection molding machines 3A and 3B for performing injection mold of disk substrates 2 and a cool air cooling device 4 for cooling injection-molded disk substrates 2 to a predetermined temperature.

Further, the optical disk manufacturing apparatus 1 is provided with a sputtering device 6 for forming a reflection film on a disk substrate 2 transferred from the cool air cooling device 4 on a conveyor 5 by a transfer device 17 and a transfer device 7 for taking out the disk substrate 2 formed with the reflection film from the conveyer 5 or transferring the same thereon.

Further, the optical disk manufacturing apparatus 1 is provided with a stocking device 8 for stocking disk substrates 2 taken out from the conveyor 5 by the transfer device 7 for a fixed time, a transfer device 9 for taking out the disk substrates 2 from the conveyor 5, and a laminating device 10 for laminating each two disk substrates 2 of the disk substrates transferred by the transfer device 9 as one pair.

Here, the injection molding machine 3A and the injection molding machine 3B are arranged in parallel so as to be spaced from each other and respective disk substrates 2 are formed by two injection molding machines 3A and 3B.

Cooling conveyors 11A and 11B which constitute transfer means for transferring disk substrates 2 in a standing state are provided in the cool air cooling device 4.

Transfer devices 12A and 12B are provided on sides of the cooling conveyors 11A and 11B where disk substrates 2 are carried in between the injection molding machine 3A and the injection molding machine 3B.

Next, details of the cool air cooling device 4 will be explained with reference to FIG. 2

An air conditioning chamber surrounding the entire of the cooling conveyer 11A along a conveying direction of the disk substrate 2 is formed in the cool air cooling device 4.

Therefore, the disk substrates 2 can be cooled effectively without discharging cool air outside.

Incidentally, it is preferable that the air conditioning chamber has a wind tunnel structure with transparency such that inside state of the air conditioning chamber can be recognized sufficiently.

A duct Din which constitutes cool air supplying means for supplying cool air inside is provided at an upper portion of the air conditioning chamber.

Thereby, the disk substrates 2 placed on the cooling conveyer 11A are cooled to a fixed temperature (for example, 20 to 25° C.),

Cool air R is fed from a cooling device (not shown) into the duct Din by a blower.

Cool air R flowed from the duct Din is spread at an upper wall portion of the cool air cooling device 4 to be supplied to the air conditioning chamber from a blowout port N constituting cool air blowing means.

Therefore, cool air is blown from the above toward disk substrates 2 in a standing state.

Then, the disk substrates 2 can be cooled to a desired temperature (for example, about 23° C.) by staying the disk substrates 2 in a predetermined time while transferring them inside the air conditioning chamber.

Cool air R which has passed through the disk substrates 2 is discharged from a discharge port Dout provided at a lower side of a side face of the cool air cooling device 4.

Incidentally, a plurality of leg portions 18 for height adjustment are provided at a lower end of the cool air cooling device 4.

Next, the cool air cooling device 4 will be further explained in detail with reference to FIG. 3 to FIG. 5.

FIG. 3 is a front view of a portion of the cool air cooling device 4 positioned near the cooling conveyer 11A.

Incidentally, the cool air cooling device 4 includes two row flows of disk substrates.

FIG. 4 is a plan view of the portion shown in FIG. 3, and FIG. 5 is a sectional view of the portion taken along line A-A in FIG. 4.

The cooling conveyer 11A is provided with three feed screw shafts 13A to 13C for left reed.

Similarly the cooling conveyer 11B is provided with three feed screw shafts 14A to 14C for right reed.

The feed screw shafts 13A to 13C and the 14A to 14C are rotatably supported by side plates 15 and 16 disposed at front and rear sides thereof via bearings (not shown) in a standing manner.

Then, pulleys P2 and P3 are attached to left ends of the feed screw shafts 13A and 13C inserted into the side plate 15 to be protruded.

A timing belt B is engaged with the pulley P1 fixed to an output shaft of a motor M1 which constitutes a generating machinery, and the timing belt B is further engaged with pulleys P2 and P3 while tension of the timing belt B is being adjusted by a tension pulley P4.

A pulley is attached to right ends of the feed screw shafts 13B and 13C inserted into the side plate 16 to be protruded and the pulley is engaged with the timing belt B while tension thereof is being adjusted by a tension pulley.

Then, when the motor M1 is rotated, the three feed screw shafts 13A to 13C are rotated in synchronism with rotation of the motor M1 via the timing belt B.

On the other hand, a pulley is attached to right ends of the feed screw shafts 14A and 14C inserted into the side plate 16 to be protruded like the left ends of the feed screw shafts 13A and 13C.

The pulley fixed to an output shaft of a motor M2 which constitutes a generating machinery is engaged with a timing belt B and the timing belt B is engaged with a pulley attached to a right end of the feed screw shaft 14C while tension thereof is being adjusted by a tension pulley.

Pulleys P5 and P6 are provided on left ends of the feed screw shafts 14B and 14C inserted into the side plate 15 to be protruded, respectively.

A timing belt B is then engaged with the pulleys P5 and P6 while tension thereof is being adjusted by a tension pulley P7.

Next, when the motor M2 is rotated, the three feed screw shafts 14A to 14C are rotated in synchronism with rotation of the motor M2 via the timing belt B.

A disk substrate 2 on the side of the cooling conveyer 11A is supported such that outer peripheral ends of both sides thereof are caught in screw grooves of the feed screw shaft 13A and the feed screw shaft 13B to be supported and it is also supported such that an outer peripheral end of the disk substrate 2 at a lower end position thereof is put in a screw groove of the feed screw shaft 13C.

Therefore, since the disk substrate 2 is supported and placed in a state that it contacts with the feed screw shafts at three points, it is maintained in its standing state.

As shown in FIG. 3, incidentally, the feed screw shafts 13A to 13C and the feed screw shafts 14A to 14C are each sectioned to a first region portion S1, a second region portion S2, and an intermediate region portion S3, and details of these portions will be explained below with reference to FIG. 6.

As shown in FIG. 6, the feed screw shaft 13A has the first region portion S1 (for example, a length of 500 mm) which is positioned on a carrying-in side of disk substrates 2, the second region portion S2 (for example, a length of 300 mm) positioned on a carrying-out side of disk substrates 2, and the intermediate region portion S3 (for example, a length of 100 mm) provided between the first region portion S1 and the second region portion S2.

Further, a pitch PT1 (for example, 6 mm) of threads formed on the first region portion S1 is set to be larger than a pitch PT2 (for example, 4 mm) of threads formed on the second region portion S2.

A pitch of threads formed on the intermediate region portion S3 is then set such that the pitch gradually becomes smaller from the side of the first region portion S1 toward the side of the second region portion S2, that is, specifically, the pitch decreases gradually in a range of PT1 to PT2.

Then, the disk substrates 2 are transferred in a direction of arrow in FIG. 6 according to rotation of the feed screw shaft 13A while they are fit between two threads on the feed screw shafts and supported by the feed screw shafts.

In the cool air cooling device of the present invention, since the second region portion S2 having the smaller pitch PT2 is provided, many disk substrates to be accommodated can be secured.

Incidentally, in an initial stage after injection molding, since warps of disk substrates 2 due to their potential heats are not cancelled, it is preferable that mutual intervals of substrates are set to be rather board.

In the first region portion S1 where the disk substrates 2 are put in a relatively high temperature state (for example, about 80° C.), since intervals among the disk substrates are made board, heat influence among the substrates can be reduced as much as possible.

Further, since contact of substrates with each other can be prevented and cool wind can be supplied between the disk substrates sufficiently, so that effective cooling of the disk substrates 2 can be achieved.

Then, since entire pitches are not made uniform so as to conform with the large pitch PT1 of threads in the first region portion S1, it is made unnecessary to make the air conditioning chamber large so that many disk substrates 2 can be accommodated in a limited cooling space compactly and efficiently.

Next, operation of the cool air cooling device 4 will be explained with reference to FIG. 1.

By first actuating the motors M1 and M2 (described in FIG. 3), disk substrates 2 placed on the cooling conveyers 11A and 11B inside the air conditioning chamber of the cool air cooling device 4 can be put in such a state that they can be transferred.

That is, the three feed screw shafts 13A to 13C and the three feed screw shafts 14A to 14C (described in FIG. 4) which constitutes the cooling conveyers 11A and 11B are respectively rotated synchronously at a constant revolution speed.

Next, disk substrates 2 injection-molded by the injection molding machine 3A are supplied to the first region portions S1 (see FIG. 6) side of the cooling conveyers 11A and 11B by the transfer devices 12A and 12B.

The disk substrates 2 supplied to the first region portions S1 side of the three feed screw shafts 13A to 13C and the three feed screw shafts 14A to 14C constituting the cooling conveyers 11A to 11B are transferred to the second region portion S2 side while they are fitted into the thread grooves with the pitch PT1 and supported at three points.

The disk substrates 2 just injection-molded are cooled by cool air R supplied in the air conditioning chamber via the duct D (see FIG. 2) during transfer thereof.

The disk substrates 2 transferred inside the air conditioning chamber in a standing state is transferred in the carrying-in side region by the feed screw shafts with a large pitch PT1.

That is, the disk substrates 2 can be transferred in this region in a low density state.

Therefore, cool air R blown toward the disk substrates 2 from the duct D at the upper portion of the air conditioning chamber via the blowing port N passes through between mutually adjacent disk substrates sufficiently so that the disk substrates 2 having relatively high temperatures can be cooled efficiently.

Further, since the pitch PT1 is large, thermal influence among substrates is reduced so that contact between substrates can be prevented.

When the disk substrates 2 reach the second region portion S2 via the intermediate region portion S3, since the pitches PT2 of the feed screw shafts are reduced, the feeding velocity lowers so that a staying time becomes long.

In this portion, the disk substrates 2 can be accommodated at a high density.

In the second region portion S2, namely, in the carrying-out side region, since the disk substrates 2 have been cooled to approximately a predetermined temperature (for example, about 23° C.), there is no concern about thermal influence among substrates and warps of the disk substrates 2 are approximately terminated or cancelled, so that contact between substrates does not occur.

As described above, in the second region portion S2, since the board pitch PT1 similar to that in the first region portion S1 is not set and a smaller pitch PT2 is set, a cooling capacity (the number of disk substrates 2 to be cooled) can be increased eventually without elongating the air conditioning chamber as a whole.

As described above, the intermediate region portion S3 whose pitch gradually decreases from the first region portion S1 to the second region portion S2 is provided on the feed screw shaft.

Therefore, the velocity of the disk substrates 2 during transfer is prevented from lowering rapidly so that contacting portions of the substrates with the three feed screw shafts 13A to 13C and the three feed screw shafts 14A to 14C supporting the disk substrates and placing them thereon are not applied with excessive load.

Now, the respective disk substrates 2 cooled down to the desired temperature by the cool air cooling device are transferred and placed on the conveyer 5, they are transferred to the sputtering device 6 for forming reflection films on the disk substrates 2, and they are further transferred to the laminating device 10 described above via the various steps.

A Step such as an inspection step is performed, if necessary, as described below.

[Examples where the number of disk substrate flows is increased]

A cool air cooling device where the number of disk substrate flows in the cool air cooling device explained above is increased to four row flows is shown in FIG. 7.

Here, one disk substrate 2A is supported and placed at three points by three feed screw shafts X, 13Y, and 13Z, and another disk substrate 2B is similarly supported and placed at three points by three feed screw shafts X, 14Y, and 14Z.

Then, the feed screw shaft X is shared as supporting points for supporting both the disk substrates 2A, 2B.

That is, three points are used for supporting a disk substrate but one point of the three points is shared for supporting adjacent disk substrates.

In FIG. 7, since disk substrates to be cooled are arranged in four row flows, when a supporting method as shown in FIG. 5 is adopted, twelve feed screw shafts are required.

However, this supporting method is adopted, only nine feed screw shafts are required, so that the number of parts is reduced, which results in high efficiency.

As shown in FIG. 7, further, when all the feed screw shafts are coupled using a timing belt B, a whole system can be synchronized, where only one motor (not shown) is required.

Though the present invention has been explained above, the present invention is not limited to the above-described embodiments, and it can be variously modified within the scope of the invention.

For example, the number of feed screw shafts is not limited to three and it may be four or more. In short, only the number of feed screw shafts where disk substrates can be supported and transferred is required.

Further, a design where distribution of pitches has been changed properly can be adopted considering improvement in cooling efficiency and an accommodation amount of disk substrates 2.

Furthermore, as the driving means for driving feed screw shafts, various driving means except for the driving means explained in the figure can be adopted.

Industrial Applicability

The present invention relates to the cool air cooling device for optical disks provided with the transfer means which transfers disk substrates in a standing state, but it can be widely applied to another field, for example, a field for cooling plate-like works having heat distortion properties as long as such a point that the pitch of threads formed on a feed screw shaft differs according to the axial positions of the threads is utilized, which is the principle of the present invention, is utilized.

### BRIEF DESCRIPTION OF THE DRAWINGS

FIG. 1 is an explanatory view including a cool air cooling device for optical disks according to one embodiment of the present invention;

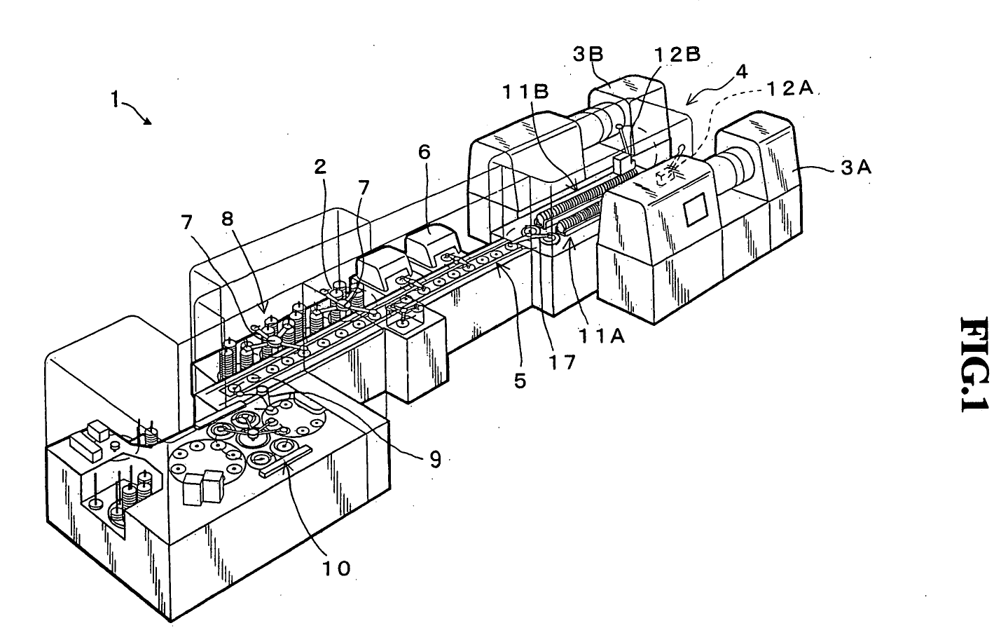

FIG. 2 is a front view showing an internal structure of the cool air cooling device shown in FIG. 1;

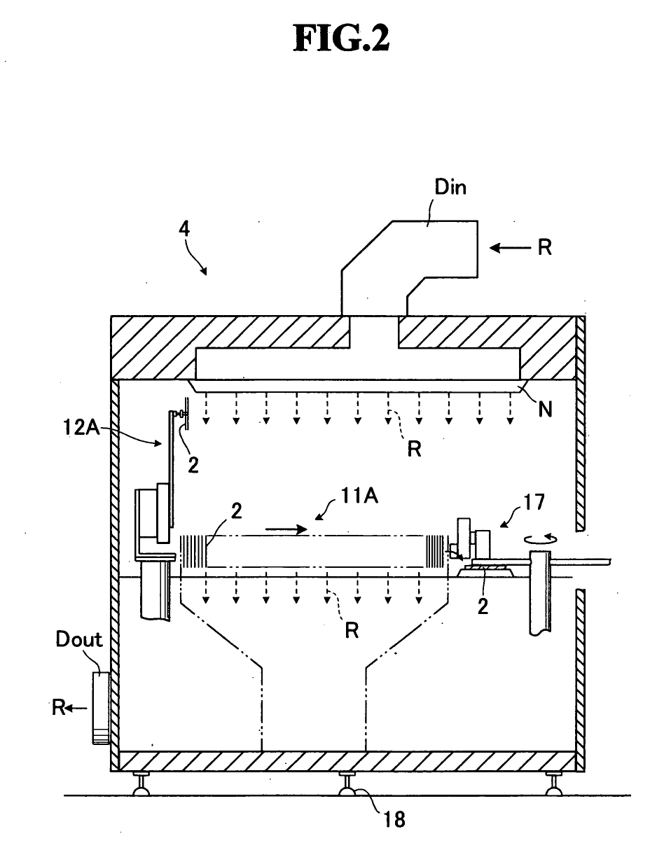

FIG. 3 is a front view showing an internal structure of the cool air cooling device shown in FIG. 1;

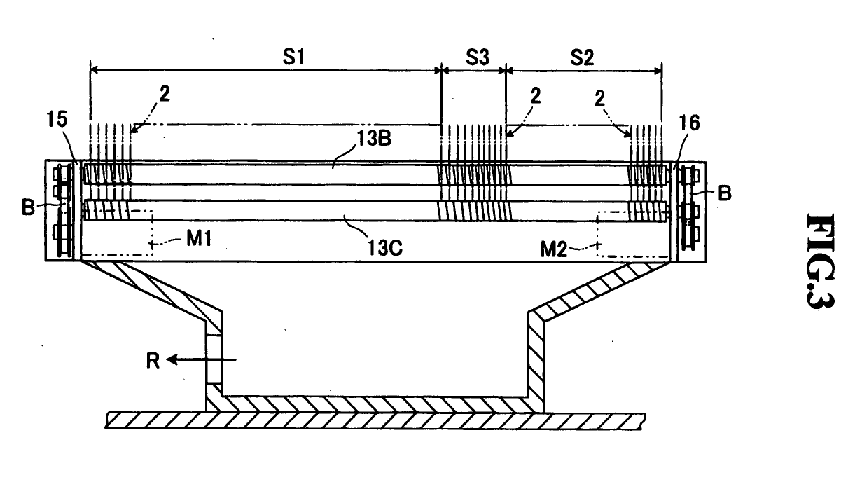

FIG. 4 is a plan view of the cool air cooling device shown in FIG. 3;

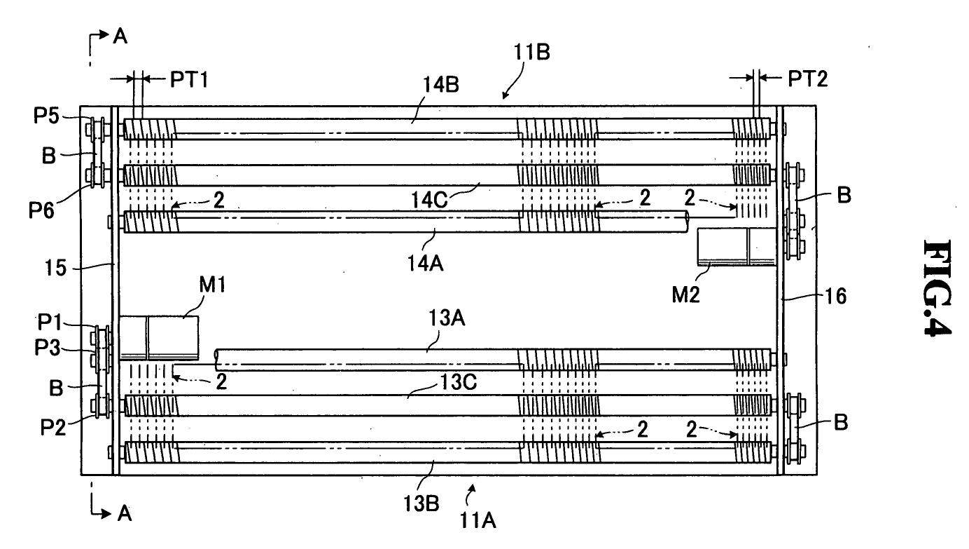

FIG. 5 is a sectional view of the cool air cooling device taken along line A-A shown in FIG. 4;

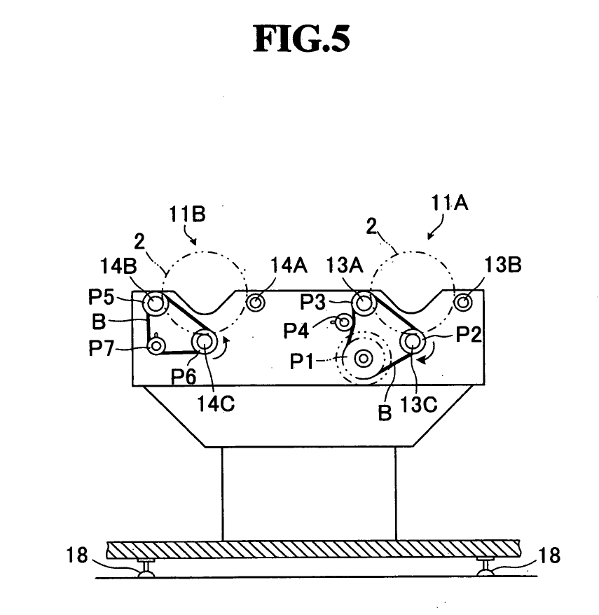

FIG. 6 is an explanatory view showing details of a feed screw shaft shown in FIG. 4; and

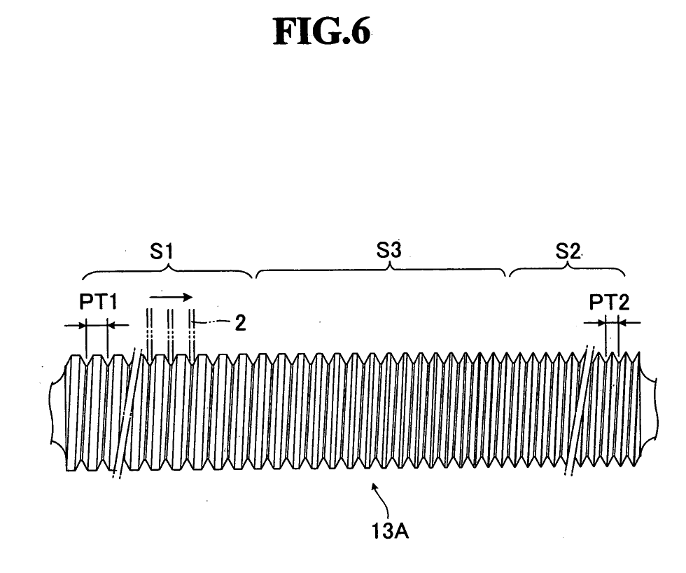

FIG. 7 is an explanatory view showing a cool air cooling apparatus with four row flows.

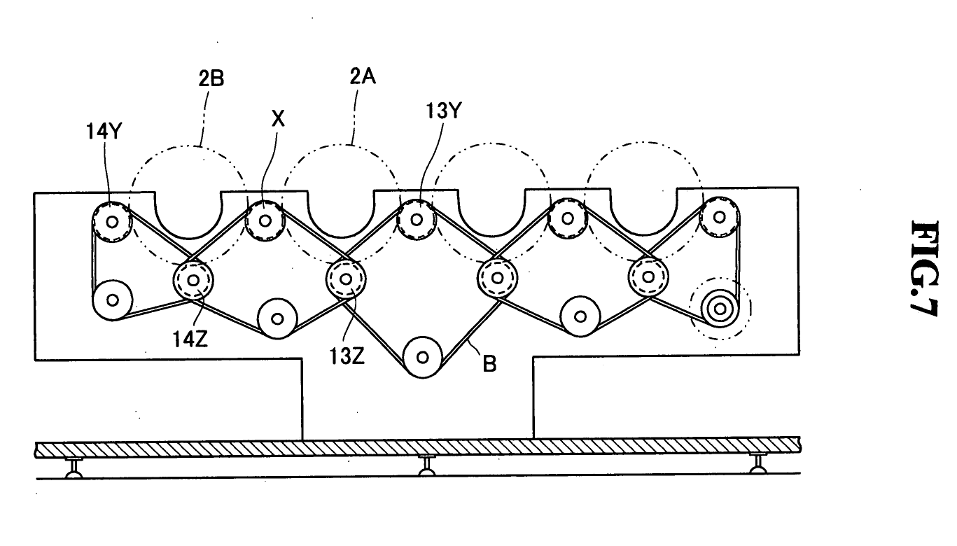

### EXPLANATION OF REFERENCE NUMERALS

1: optical disk manufacturing apparatus
2, 2A, 2B: disk substrate
3A, 3B: injection-molding machine
4: cool air cooling device
5: conveyer
6: sputtering device
7, 9, 12A, 12B, 17: transfer device
8: stocking device
10: laminating device
11A, 11B: cooling conveyer
13A to 13C, 14A to 14C: feed screw shaft
15, 16: side plate
18: leg portion
B: timing belt
Din: duct
Dout: discharge port
M1, M2: motor
N: blowing port
P1 to P3, P5, P6: pulley
P4, P7: tension pulley
PT1, PT2: pitch
S1: first region portion
S2: second region portion
S3: intermediate region portion
R: cool air

1. A cool air cooling device for optical disks having transfer means for transferring disk substrates in a standing state, wherein
the transfer means is provided with a plurality of feed screw shafts driven for synchronous rotation to support and place disk substrates at a plurality of points, and
the pitch of threads formed on the feed screw shaft differs according to axial positions of the threads.

2. A cool air cooling device for optical disks according to claim 1, wherein
the feed screw shaft has
a first region portion positioned at a carrying-in side of disk substrates and
a second region portion positioned at a side of carrying-out of disk substrates, and
a pitch of the threads formed on the first region portion is larger than a pitch of the threads formed on the second region portion.

3. A cool air cooling device for optical disks according to claim 2, wherein
an intermediate region portion whose pitch gradually decreases from the first region portion to the second region portion is provided between the first region portion and the second region portion.

4. A cool air cooling device for optical disks according to claim 2, wherein
the first region portion is longer than the second region portion.

5. A cool air cooling device for optical disks according to claim 1, further comprising
cool air blowing means for blowing cool air toward the disk substrates in the standing state from the above.

6. A cool air cooling device for optical disks according to claim 1, further comprising
an air conditioning chamber for covering the disk substrates in a standing state, and cool air supplying means for supplying cool air to the air conditioning chamber.

7. A cool air cooling device for optical disks according to claim 1, wherein
the disk substrates are supported at three points, and one point of the three points is shared for supporting adjacent disk substrates.
